(19) United States
(12) Patent Application Publication
(10) Pub. No.: US 2006/0279065 A1
(43) Pub. Date: Dec. 14, 2006

(54) Message on rotating wheel

(76) Inventor: Sheldon R. Reed, Alva, FL (US)

Correspondence Address: Sheldon R. Reed, 1720 Werner Rd, Alva, FL, 33920, US

(21) Appl. No.: 11/140,094

(22) Filed: May 31, 2005

(51) Int. Cl. B62J 39/00

(52) U.S. Cl. 280/288.4

(57) ABSTRACT

A virtual image writer device is mounted on a wheel which will exhibit a text message when the wheel is rotated. The system is enclosed in a casing and has a series of LED light thereon which can be seen as a streak of lights which streak display a message. The text of the message is changeable at will.

### FIELD OF THE INVENTION

The field of the invention is found in the art of providing a message in the form of a short text in a novel and fun arrangement. This is done by providing a text on a wheel while it is rotating.

### BACKGROUND OF THE INVENTION

There are many known displays of messages or texts on vehicles either by way of bumberstickers or by signs in a window. Other designs are used to display a message on an electronic board in the rear window of a vehicle. Such messages are changeable at will either by hand or by remote control.

### BRIEF DESCRIPTION OF THE INVENTION

The inventive display of messages or texts involves a system that is mounted on a wheel of either a bicycle or a motor vehicle and will display its message while rotating when the vehicle is rolling. This is done by an electronic system involving LED's that are activated by centrifugal force when the casing containing the LED's is being rotated. The basic system is known from the U.S. Pat. No. D442,597 which shows a hand-held device which must be rotated over one's head by a twirling device which is held in the hand of the user. More detailed instructions can be gleaned from the internet under www.theskyliner.com. However the known system cannot be mounted on any wheels to be rotated thereby. There is no disclosure that this can be or should be done. The disclosed device has been modified to the extent that it is contained in a small casing which has ways thereon so that it can be mounted on the spokes of a bicycle or an a wheel of a motor vehicle.

### BRIEF DESCRIPTION OF THE DRAWINGS

FIG. 1 illustrates the casing that contains the electronic elements of the device;

FIG. 2 shows the device of FIG. 1 mounted in detail on a vehicle wheel;

FIG. 3 shows the device of FIG. 1 mounted on a wheel in a perspective view;

FIG. 4 shows the casing of FIG. 1 in a modified form so that it can be mounted on a bicycle wheel;

FIG. 5 illustrates the casing of FIG. 4 mounted on a bicycle wheel.

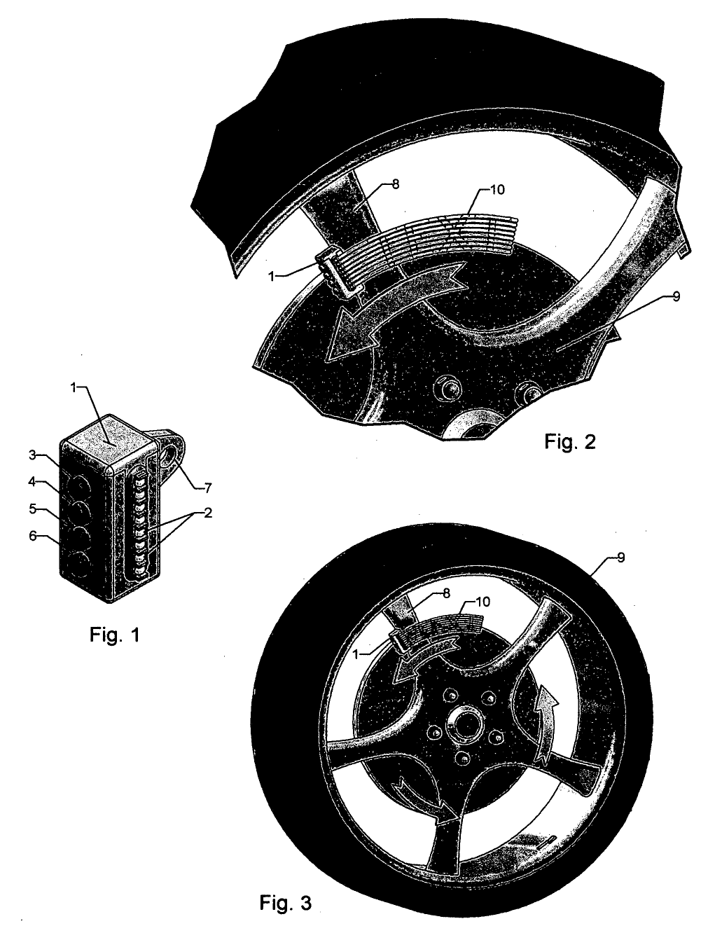

### DETAILED DESCRIPTION OF THE INVENTION

Figure illustrates a casing 1 that contains all of the necessary components known in the prior art and a detailed description is not deemed to be necessary. The known prior device, identified above, has been modified to an extent that it is contained in a small casing that can easily be mounted on a rotating wheel. The electronic lights in the form of LED's are shown at 2 and are so located that they face outwardly away from the surface of the wheel so that they can easily be seen by an observer. As is well known, there at least four buttons 3-6 that are used to select predetermined texts to be displayed. Thus, the casing and the electronic display is pre-programmed to display certain texts, messages or logos. On the other hand it is known that this device can be programmed so that individual and personal messages can be displayed. At 7 there is shown a flange to be used for the casing to be mounted on a motor vehicle wheels either to its rim or a spoke design thereon.

The casing 1 must be so designed so that it is weatherproof because it could be used in all kinds of weather so that it does not have be dismounted from the wheel whenever there is an inclement weather.

It is also visualized that the electronic system within the casing 1 can reprogrammed by a remote device located within the vehicle, for example. This could be done by a keypad within the vehicle or hand held.

To keep the casing as small as possible, it is suggested that the well known button batteries are to be used. The batteries could be recharged, when the device is not in use by kinetic energy such as is being used in a self-winding watch. The kinetic energy is being derived from the wheel in motion.

It is also suggested that a position sensing element be incorporated into the device so that the displayed text will stay oriented at the top of the wheel as the speed of the wheel varies. This could be a magnetic trip on the vehicle or any other means.

The device could be programmed to display decorative patterns beside or in addition to a text.

The device could be modified in size to show larger arrays instead of the known prototype of 1½ inches.

It is also contemplated that a multiple of colors should be displayed.

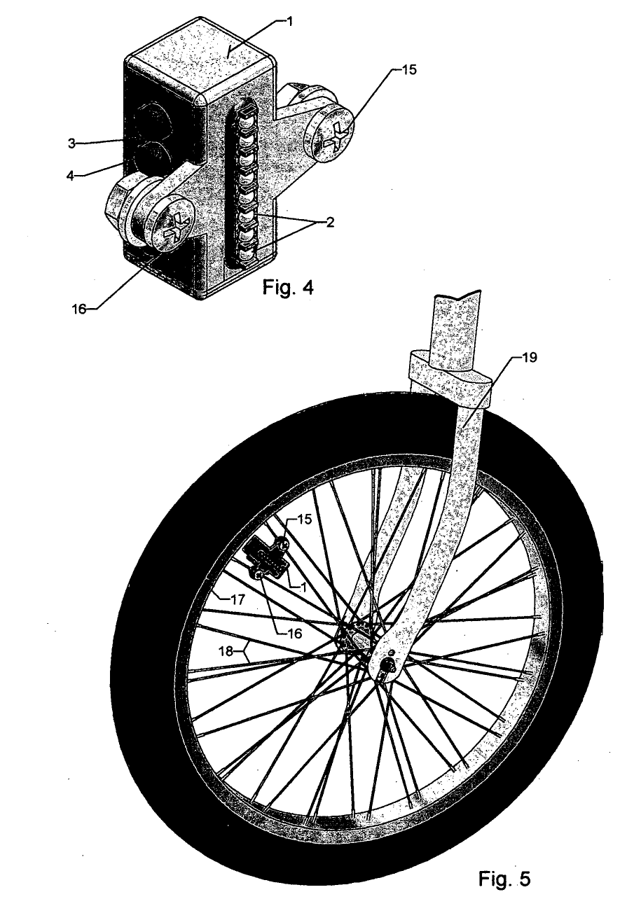

FIGS. 2 and 3 show the casing 1 installed on a wheel 9 by way of a flange 7 that can be attached to the rim of the wheel or on a spoke 8 of the wheel 9. At 10 there is shown simulated text as it would appear when the wheel 9 is rotating.

FIG. 4 shows the casing 1 with two flanges attached thereto so that it can be mounted on the spokes of the bicycle wheel 17 having the spokes 18. The screws 15 and 16 simply clamp the casing to the spokes 18. Of course, the bicycle wheel 17 is mounted in the front fork 19 of the bicycle as is well known.

What I claim is:

1. A text messaging system mounted on a wheel, said system having Led lights thereon, said LED lights are activated when said wheel is rotated to thereby exhibit a streak of lights of the text to be messaged as a virtual image, said system including means for selecting different messages.

2. The system of claim 1, wherein said system is contained in a casing, said casing having means thereon for being mounted on a wheel.

3. The system of claim 2, said casing having a lateral flange thereon for being mounted on wheel of a motor vehicle.

4. The system of claim 2, said casing having two lateral flanges thereon for each flange to be mounted on a spoke of a bicycle wheel.
